(19) United States
(12) Patent Application Publication
(10) Pub. No.: US 2017/0080692 A1
(43) Pub. Date: Mar. 23, 2017

(54) Polymer Film Structures and Articles Made Therefrom

(71) Applicant: Dow Global Technologies LLC, Midland, MI (US)

(72) Inventors: Joao Gargalaka, JR., Jundiai/SP (BR); Jorge C. Gomes, Jundiai/SP (BR); Michael L. Mounts, Midland, MI (US); Nicholas C. Mazzola, Jundiai/SP (BR); Marcelo D. Cantu, Jundiai/SP (BR)

(21) Appl. No.: 15/312,226

(22) PCT Filed: Apr. 28, 2015
(86) PCT No.: PCT/US2015/027948

§ 371 Date: Nov. 18, 2016

Related U.S. Application Data
(60) Provisional application No. 62/000,575, filed on May 20, 2014.

(51) Int. Cl. B32B 27/30; B32B 27/32; B32B 27/08

(52) U.S. Cl. CPC B32B 27/304; B32B 27/08; B32B 27/306; B32B 27/308; B32B 27/32; B32B 2250/24; B32B 2270/00; B32B 2307/538; B32B 2307/54; B32B 2307/582; B32B 2307/7244; B32B 2307/7246; B32B 2307/738; B32B 2439/00

(57) ABSTRACT

A film structure comprising: a first surface layer which comprises a polymeric material selected from the group consisting of LLDPE, MDPE, and polypropylene and blends thereof, wherein the polymeric material has a melting point of at least 95° C. and a total crystallinity from 25 to 45%; a first tie layer comprising at least one component selected from the group consisting of EVA, EEA, EMA, and EBA; an internal layer which comprises a PVDC copolymer; and a second surface layer which comprises an LLDPE having a density of from 0.865 to 0.925 g/cm3 and a melt index, I₂, of less than 6.0 g/10 min, and wherein the internal layer represents from 6 to 25% of a total thickness of the film structure is provided. Also provided are articles made from the film structure.

### FIELD OF INVENTION

The instant invention relates to a polymeric film structures and articles made therefrom.

### BACKGROUND OF THE INVENTION

Polyvinylidene chloride (PVDC) resins are known as an excellent barrier material for several applications due to their unique combination of oxygen and moisture barrier as well as the maintenance of oxygen barrier with moisture exposure. However, the use of PVDC as an oxygen and moisture barrier layer for thermoforming package is limited due to the processing conditions required. Standard thermoforming films are based on polyamide materials and require high extrusion temperatures ranges that increase dramatically the tendency of PVDC degradation.

### SUMMARY OF THE INVENTION

The instant invention includes polymer film structures and articles made therefrom.

In one embodiment, the instant invention provides a process for making a hydrophilic nonwoven structure comprising forming a nonwoven structure comprising fibers; and exposing the nonwoven structure to an atmospheric plasma comprising an inert gas and a substance having a polar group and which can be vaporized or made into an aerosol and which forms a free radical upon exposure to a dielectric barrier discharge.

### DETAILED DESCRIPTION OF THE INVENTION

The instant invention is a process for making a hydrophilic nonwoven structure, a nonwoven structure produced thereby and an article containing the nonwoven structure.

The term “polymer”, as used herein, refers to a polymeric compound prepared by polymerizing monomers, whether of the same or a different type. The generic term polymer thus embraces the term “homopolymer”, usually employed to refer to polymers prepared from only one type of monomer as well as “copolymer” which refers to polymers prepared from two or more different monomers.

“Polyethylene” shall mean polymers comprising greater than 50% by weight of units which have been derived from ethylene monomer. This includes polyethylene homopolymers or copolymers (meaning units derived from two or more comonomers). Common forms of polyethylene known in the art include Low Density Polyethylene (LDPE); Linear Low Density Polyethylene (LLDPE); Ultra Low Density Polyethylene (ULDPE); Very Low Density Polyethylene (VLDPE); single site catalyzed Linear Low Density Polyethylene, including both linear and substantially linear low density resins (m-LLDPE); and High Density Polyethylene (HDPE). These polyethylene materials are generally known in the art; however the following descriptions may be helpful in understanding the differences between some of these different polyethylene resins.

The term “LDPE” may also be referred to as “high pressure ethylene polymer” or “highly branched polyethylene” and is defined to mean that the polymer is partly or entirely homopolymerized or copolymerized in autoclave or tubular reactors at pressures above 14,500 psi (100 MPa) with the use of free-radical initiators, such as peroxides (see for example U.S. Pat. No. 4,599,392, herein incorporated by reference). LDPE resins typically have a density in the range of 0.916 to 0.940 g/cm³.

The term “LLDPE”, includes both resin made using the traditional Ziegler-Natta catalyst systems as well as single-site catalysts such as metallocenes (sometimes referred to as “m-LLDPE”) and includes linear, substantially linear or heterogeneous polyethylene copolymers or homopolymers. LLDPEs contain less long chain branching than LDPEs and includes the substantially linear ethylene polymers which are further defined in U.S. Pat. No. 5,272,236, U.S. Pat. No. 5,278,272, U.S. Pat. No. 5,582,923 and U.S. Pat. No. 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or U.S. Pat. No. 5,854,045). The Linear PE can be made via gas-phase, solution-phase or slurry polymerization or any combination thereof, using any type of reactor or reactor configuration known in the art, with gas and slurry phase reactors being most preferred.

The term “MDPE” refers to polyethylenes having densities from 0.926 to 0.940 g/cm³. “MDPE” is typically made using chromium or Ziegler-Natta catalysts or using metallocene, constrained geometry, or single cite catalysts, and typically have a molecular weight distribution (“MWD”) greater than 2.5.

The term “HDPE” refers to polyethylenes having densities greater than about 0.940 g/cm3, which are generally prepared with Ziegler-Natta catalysts, chrome catalysts or even metallocene catalysts.

“Multimodal” means resin compositions which can be characterized by having at least two distinct peaks in a GPC chromatogram showing the molecular weight distribution. Multimodal includes resins having two peaks as well as resins having more than two peaks.

“Polypropylene” shall mean polymers comprising greater than 50% by weight of units which have been derived from propylene monomer. This includes homopolymer polypropylene, random copolymer polypropylene, and impact copolymer polypropylene. These polypropylene materials are generally known in the art. “Polypropylene” also includes the relatively newer class of polymers known as propylene based plastomers or elastomers (“PBE” of “PBPE”). These propylene/alpha-olefin copolymers are further described in details in the U.S. Pat. Nos. 6,960,635 and 6,525,157, incorporated herein by reference. Such propylene/alpha-olefin copolymers are commercially available from The Dow Chemical Company, under the tradename VERSIFY, or from ExxonMobil Chemical Company, under the tradename VISTAMAXX.

The following analytical methods are used in the present invention:

Density is determined in accordance with ASTM D792.

“Melt index” also referred to as “I₂” is determined according to ASTM D1238 (190° C., 2.16 kg).

Peak melting point is determined by Differential Scanning calorimeter (DSC) where the film is conditioned at 230° C. for 3 minutes prior to cooling at a rate of 10° C. per minute to a temperature of −40° C. After the film is kept at −40° C. for 3 minutes, the film is heated to 200° C. at a rate of 10° C. per minute.

The term molecular weight distribution or “MWD” is defined as the ratio of weight average molecular weight to number average molecular weight (Mw/Mn). M_{w} and Mₙ are determined according to methods known in the art using conventional gel permeation chromatography (conventional GPC).

Water Vapor Transmission Rate (or WVTR) is determined according to ASTM E 96/E 96 M-05.

2% Secant Modulus-MD (machine direction) and CD (cross direction): ASTM D882-10 (average of five film samples in each direction; each sample “1 in×6 in”).

MD and CD Elmendorf Tear Strength: ASTM D1922-09 (average of 15 film samples in each direction; each sample “3 in×2.5 in” half moon shape).

MD and CD Tensile Strength: ASTM D882-10 (average of five film samples in each direction; each sample “1 in×6 in”).

Dart Impact Strength: ASTM D1709-09 (minimum of 20 drops to achieve a 50% failure; typically ten “10 in×36 in” strips).

Puncture Strength: Puncture was measured on an INSTRON Model 4201 with SINTECH TESTWORKS SOFTWARE Version 3.10. The specimen size was “6 in×6 in,” and four measurements were made to determine an average puncture value. The film was conditioned for 40 hours after film production, and at least 24 hours in an ASTM controlled laboratory (23° C. and 50% relative humidity). A “100 lb” load cell was used with a round specimen holder of 4 inch diameter. The puncture probe is a “½ inch diameter” polished stainless steel ball (on a 2.5″ rod) with a “7.5 inch maximum travel length.”

There was no gauge length, and the probe was as close as possible to, but not touching, the specimen (the probe was set by raising the probe until it touched the specimen). Then the probe was gradually lowered, until it was not touching the specimen. Then the crosshead was set at zero. Considering the maximum travel distance, the distance would be approximately 0.10 inch. The crosshead speed was 10 inches/minute. The thickness was measured in the middle of the specimen. The thickness of the film, the distance the crosshead traveled, and the peak load were used to determine the puncture by the software. The puncture probe was cleaned using a “KIM-WIPE” after each specimen.

In a first embodiment, the invention provides a film structure suitable for use in thermoforming applications comprises a first surface layer which comprises a polymeric material selected from the group consisting of LLDPE, MDPE, HDPE, polypropylene and blends thereof, wherein the polymeric material has a melting point of at least 95° C. and a total crystallinity in the range of 25 to 45%; a first tie layer comprising at least one component selected from the group consisting of ethylene vinyl acetate copolymers (EVA), ethylene-acrylic acid copolymer (EAA), ethylene-methacrylic acid copolymer (EMA) and ethylene butyl acrylate copolymer (EBA); an internal layer which comprises a polyvinylidene chloride (PVDC) copolymer; and a second surface layer which comprises an LLDPE having a density of from 0.865 to 0.925 g/cm³ and a melt index, I₂, of less than 6.0 g/10 min, and wherein the film structure is characterized by comprising less than 10% by weight of the film of total amount of components selected from the group consisting of polyamides, polyesters, ethylene vinyl acetate, ionomers, polyvinyl chloride, and cyclic olefin polymers, and wherein the internal layer represents from 6 to 25% of a total thickness of the film structure.

In a second embodiment the invention provides an article comprising the film structure according to any embodiment described herein.

In an alternative embodiment, the article is configured to hold liquids, particulates and/or solids.

The first surface layer of the film structure comprises a polymeric material selected from the group consisting of LLDPE, MDPE, propylene-based plastomers, propylene-based elastomers and blends thereof. In one embodiment, the polymeric material may be a blend of any two or more selected from the group consisting of LLDPE, MDPE, and polypropylene.

The LLDPE used in the first surface layer of the film structure can have a density from 0.912 to 0.925 g/cm³. All individual values and subranges of an LLDPE density from 0.912 to 0.925 g/cm³ are included and disclosed herein. For example, the density of the LLDPE can be from a lower limit of 0.912, 0.914, 0.916, 0.918, 0.92, or 0.922 g/cm³ to an upper limit of 0.913, 0.915, 0.917, 0.919, 0.921, 0.923 or 0.925 g/cm³. For example, the density of the LLDPE can be from 0.912 to 0.925 g/cm³, or in the alternative, from 0.912 to 0.919 g/cm³, or in the alternative, from 0.918 to 0.925 g/cm³, or in the alternative, from 0.916 to 0.922 g/cm³, or in the alternative, from 0.915 to 0.920 g/cm³.

The LLDPE used in the first surface layer of the film structure can have a melt index (I₂) less than or equal to 6.0 g/10 min. All individual values and subranges from less than or equal to 6.0 g/10 min are included herein and disclosed herein; for example, the melt index of the LLDPE can be from an upper limit of 6.0, 5.5, 5.0 or 4.5 g/10 min. In a particular embodiment, the melt index (I₂) is greater than or equal to 0.1 g/10 min. All individual values and subranges from greater than or equal to 0.1 g/10 min are included and disclosed herein; for example, the melt index can be from a lower limit of 0.1, 0.5, 1, or 3 g/10 min.

In a particular embodiment, the first surface layer comprises LLDPE having a melt strength at 190° C. from 1 to 3 cN. All individual values and subranges from 1 to 3 cN are included and disclosed herein; for example, the melt strength of the LLDPE can be from a lower limit of 1, 1.4, 1.8, 2.2, 2.6, or 2.9 cN to an upper limit of 1.2, 1.6, 2, 2.4, 2.8 or 3 cN. For example, the melt strength of the LLDPE can be from 1 to 3 cN, or in the alternative, from 1 to 2 cN, or in the alternative, from 2 to 3 cN, or in the alternative, from 1.5 to 2.5 cN, or in the alternative, from 1.8 to 2.22 cN.

In an alternative embodiment, the first surface layer comprises a high melt strength LLDPE having a melt strength greater than 3 cN at 190° C. The high melt strength LLDPE may have a melt strength with a lower limit of 3, 3.5, 4 or 4.5 cN. In a particular embodiment, the melt strength of the LLDPE can be equal to or less than 20 cN at 190° C. All individual values and subranges from equal to or less than 20 cN at 190° C. are included and disclosed herein. For example, the melt strength can be equal to or less than 20, 15, 10 or 5 cN.

In yet another embodiment, the first surface layer comprises an MDPE. The MDPE can have a melt index (I₂) equal to or less than 6 g/10 min. All individual values and subranges from less than or equal to 6.0 g/10 min are included herein and disclosed herein; for example, the melt index of the MDPE can be from an upper limit of 6.0, 5.5, 5.0 or 4.5 g/10 min. In a particular embodiment, the melt index of the MPDE can be equal to or greater than 0.01 g/10 min. All individual values and subranges from equal to or greater than 0.01 g/10 min are included and disclosed herein; for example, the melt index can be from a lower limit of 0.01, 0.05, 1, or 3 g/10 min.

In yet another embodiment, the first surface layer comprises an HDPE. The HDPE can have a melt index equal to or less than 6 g/10 min. All individual values and subranges from less than or equal to 6.0 g/10 min are included herein and disclosed herein; for example, the melt index of the HDPE can be from an upper limit of 6.0, 5.5, 5.0 or 4.5 g/10 min. In a particular embodiment, the melt index of the HPDE can be equal to or greater than 0.01 g/10 min. All individual values and subranges from equal to or greater than 0.01 g/10 min are included and disclosed herein; for example, the melt index can be from a lower limit of 0.01, 0.05, 1, or 3 g/10 min.

In a particular embodiment, when either or both of MDPE and HDPE are present in the first surface layer of the film structure, the total amount of MDPE and HDPE constitute less than or equal to 25% of the total film structure weight. Alternatively, the amount of MDPE and HDPE may constitute less than or equal to 20, 15 or 10% of the total film structure weight, when present in the first surface layer.

The polymeric material of the first surface layer has a melting point of at least 95° C. and a total crystallinity in the range of 25 to 45%. All individual values and subranges of a melting point of at least 95° C. are included and disclosed herein; for example, the melting point can be from a lower limit of 95, 98, 101, 110 or 120° C. In a particular embodiment, the polymeric material of the first surface layer has a melting point of no greater than 170° C. All individual values and subranges from equal to or less than 170° C. are included and disclosed herein; for example, the melting point of the polymeric material can be from an upper limit of 170, 160, 150, 140 or 130° C.

All individual values and subranges of a total crystallinity from 25 to 45% are included herein and disclosed herein; for example, the total crystallinity of the polymeric material of the first surface layer can be from a lower limit of 25, 27, 29, 31, 33, 35, 37, 39, 41, or 43% to an upper limit of 26, 28 30, 32, 34, 46, 38, 40, 42, 44 or 45%. For example, the total crystallinity can be from 25 to 45%, or in the alternative, from 25 to 35%, or in the alternative, from 35 to 45%, or in the alternative, from 30 to 40%.

The film structure includes a first tie layer which comprises at least one component selected from the group consisting of ethylene vinyl acetate copolymers (EVA), ethylene-acrylic acid copolymer (EAA), ethylene-methacrylic acid copolymer (EMA) and ethylene butyl acrylate copolymer (EBA). In one embodiment, the tie layer comprises only one component selected from the group consisting of ethylene vinyl acetate copolymers (EVA), ethylene-acrylic acid copolymer (EAA), ethylene-methacrylic acid copolymer (EMA) and ethylene butyl acrylate copolymer (EBA). In an alternative embodiment, the tie layer may comprise any combination of two or more components selected from the group consisting of ethylene vinyl acetate copolymers (EVA), ethylene-acrylic acid copolymer (EAA), ethylene-methacrylic acid copolymer (EMA) and ethylene butyl acrylate copolymer (EBA).

In a particular embodiment, the tie layer comprises EVA having equal to or greater than 9 wt % units derived from vinyl acetate. All individual values and subranges from equal to or greater than 9 wt % are included and disclosed herein; for example, the amount of units derived from vinyl acetate can be from a lower limit of 9, 10, 12, or 15 wt %. In another embodiment, the amount of units derived from vinyl acetate has an upper limit of 40 wt %. All individual val 40 wt % ues and subranges from equal to or less than are included and disclosed herein; for example, the amount of units derived from vinyl acetate can be from an upper limit of 40, 30 or 20 wt %.

In an alternative embodiment, the tie layer comprises EVA having a density equal to or greater than 0.92 g/cm³. All individual values and subranges from equal to or greater than 0.92 g/cm³ are included and disclosed herein; for example, the density of the EVA can be from a lower limit of 0.92, 0.94 or 0.96 g/cm³.

In yet another embodiment, the tie layer may comprise EVA having a melt index (I₂) equal to or less than 6.0 g/10 min. All individual values and subranges from equal to or less than 6.0 g/10 min are included and disclosed herein; for example, the melt index of the EVA can be from an upper limit of 6, 4, or 2 g/10 min. In a particular embodiment, the melt index of the EVA can be from a lower limit of 0.1 g/10 min. All individual values and subranges from equal to or greater than 0.1 g/10 min are included and disclosed herein; for example, the lower limit of the melt index can be 0.1, 0.5, 1 or 1.5 g/10 min.

The internal layer of the film structure comprises a polyvinylidene chloride (PVDC) copolymer. PVDC includes crystalline copolymers, containing vinylidene chloride and one or more other monomers, including for example vinyl chloride, acrylonitrile, vinyl acetate, methyl acrylate, ethyl acrylate, ethyl methacrylate and methyl methacrylate.

In a particular embodiment, the PVDC has a density greater than or equal to 1 g/cm³. All individual values and subranges from greater than or equal to 1 g/cm³ are included and disclosed herein. For example, the PVDC can have a density from a lower limit of 1, 1.05, 1.15, 1.25 or 1.3 g/cm³. In a particular embodiment, the PVC density has an upper limit of 1.4 g/cm³.

In a particular embodiment, the PVDC includes those having a weight-average molecular weight (M_{w}) of at least any of the following 10,000; 50,000; 80,000; 90,000; 100,000; 111,000; 120,000; 150,000; and 180,000 daltons; and at most any of the following: 180,000, 170,000; 160,000; 150,000; 140,000; 100,000; and 50,000 daltons.

The internal layer represents from 6 to 25% of a total thickness of the film structure. All individual values and subranges from 6 to 25% are included herein and disclosed herein; for example, the percentage of the total film structure thickness represented by the internal layer can be from a lower limit of 6, 8, 10, 12, 14, 16, 18, 20, 22 or 24% to an upper limit of 7, 9, 11, 13, 15, 17, 19, 21, 23 or 25%. For example, the percentage of the total film structure thickness represented by the internal layer can be from 6 to 25%, or in the alternative, from 6 to 15%, or in the alternative, from 15 to 25%, or in the alternative, from 10 to 15%, or in the alternative, from 8 to 12%, or in the alternative, from 10 to 20%.

As used herein, m/uLLDPE refers to LLDPEs having a density from 0.850 to 0.925 g/cm³ which are produced using either a metallocene or Ziegler Natta catalyst. All individual values and subranges from 0.850 to 0.925 g/cm³ are included and disclosed herein; for example, the density of the m/uLLDPE can be from a lower limit of 0.85, 0.86, 0.87, 0.880, 0.885, 0.890, 0.895, 0.9, or 0.905 g/cm³ to an upper limit of 0.883, 0.888, 0.893, 0.898, 0.903, 0.908 or 0.912 g/cm³. For example, the density of the m/uLLDPE can be from 0.850 to 0.925 g/cm³, or in the alternative, from 0.850 to 0.90 g/cm³, or in the alternative, from 0.895 to 0.925 g/cm³, or in the alternative, from 0.888 to 0.906 g/cm³.

The LLDPE used in the second surface layer of the film structure has a melt index of less than or equal to 6.0 g/10 min. All individual values and subranges of an I₂, of less than 6.0 g/10 min are included and disclosed herein; for example, the I₂ of the LLDPE of the second surface layer can be from an upper limit of 6.0, 5.0, 4.0, 3.0, 2.0, or 1.5 g/10 min. In a particular embodiment, the I₂ of the LLDPE of the second surface layer can be from a lower limit of 1.0, 1.2, 1.4, 1.6 or 1.8 g/10 min.

The film structure is characterized by comprising less than or equal to10% by weight of the film structure of total amount of components selected from the group consisting of polyamides, polyesters, ethylene vinyl acetate, ionomers, polyvinyl chloride, and cyclic olefin polymers. All individual values and subranges less than 10% by weight are included and disclosed herein; for example, the percentage of the total weight of the film structure arising from components selected from the group consisting of polyamides, polyesters, ethylene vinyl acetate, ionomers, polyvinyl chloride, and cyclic olefin polymers can be from an upper limit of 10, 9, 8, 7, 6, or 5%.

The disclosure further provides the film structure and article according to any embodiment herein except that the first surface layer comprises a propylene-based plastomer or elastomer. Propylene-based plastomers and/or elastomers useful in embodiments of the invention include propylene-based polymer which comprises (A) from 60 to 95 weight percent (wt %) units derived from propylene, and (B) from 5 to 40 wt % units derived from ethylene, and characterized by a melting temperature (Tm) of less than or equal to 110° C. All individual values and subranges from at least 60 wt % units derived from propylene are included and disclosed herein; for example, the amount of polymer can be from a lower limit of 60, 65, 70, 75, 80, 85, 90 or 92 wt % to an upper limit of 62, 68, 72, 78, 82, 88, 92 or 95 wt %. For example, the amount of units derived from propylene can be from 60 to 95 wt %, or in the alternative, from 60 to 80 wt %, or in the alternative, from 70 to 95 wt %, or in the alternative, from 65 to 85 wt %. The propylene-based polymer has from 5 to 40 wt % units derived from ethylene. All individual values and subranges from 5 to 40 wt % are included and disclosed herein; for example, the amount of unit derived from ethylene can be from a lower limit of 5, 15, 25 or 35 wt % to an upper limit of 10, 20, 30 or 40 wt %. For example, the amount of units derived from ethylene can be from 5 to 40 wt %, or in the alternative, from 5 to 20 wt %, or in the alternative, from 20 to 40 wt %, or in the alternative, from 10 to 30 wt%. All individual values and subranges melting temperature (Tm) of less than or equal to 110° C. are included and disclosed herein; for example, the Tm can be less than or equal to 110, 100, 90, 80 or 70° C.

The disclosure further provides the film structure and article according to any embodiment herein except that the first surface layer comprises from 50 to 100 wt % linear low density polyethylene, MDPE, HDPE, polypropylene or blends thereof. All individual values and subranges from 50 to 100 wt % are included and disclosed herein; for example, the amount of LLDPE, MDPE, HDPE and polypropylene in the first surface layer can be from a lower limit of 50, 60 0, 80 or 90 wt % to an upper limit of 55, 65, 75, 85, 98 or 100 wt %.

The disclosure further provides the film structure and article according to any embodiment herein except that the film structure is a blown film.

The disclosure further provides the film structure and article according to any embodiment herein except that the film structure is a cast film.

The disclosure further provides the film structure and article according to any embodiment herein except that the total film structure comprises less than 35 wt % polyethylene having a density of 0.930 g/cm³ or greater, based on the total weight of the film structure.

The disclosure further provides the film structure and article according to any embodiment herein except that the inner and/or outer layer is a linear low density polyethylene polymer having a melt index (I₂) from 0.75 to 0.95 g/10 min and a density from 0.91 to 0.93 g/cc. Examples of such linear low density polyethylenes include those commercially available from The Dow Chemical Company under the name DOWLEX HMS, such as DOWLEX 8017 and DOWLEX 8018.

The disclosure further provides the film structure and article according to any embodiment herein except that the one or both of the first and second surface layers further comprises LDPE.

The disclosure further provides the film structure and article according to any embodiment herein except that the film structure has a total thickness from 25 to 300 microns, preferably 100 microns to 200 microns, more preferably 150 microns. All individual values and subranges from 25 to 300 microns are included and disclosed herein; for example, the thickness of the film structure can be from a lower limit of 25, 50, 75, 100, 125, 150, 175, 200, 225, 250 or 275 microns to an upper limit of 50, 75, 100, 125, 150, 175, 200, 225, 250, 275 or 300 microns.

The disclosure further provides the film structure and article according to any embodiment herein except that the film structure has from 4 to 15 layers. All individual values and subranges are disclosed and included herein; for example, the number of layers in the film structure can be from a lower limit of 4, 5, 7, 9, 11, or 12 layers to an upper limit of 5, 6, 7, 9, 11, 13 or 15 layers.

The disclosure further provides the film structure and article according to any embodiment herein except that the any layer of the film structure further comprises less than or equal to 10 wt % of one or more polymers selected from the group consisting of polyamide, polyesters, ionomers, cyclic olefin polymers, and EVOH.

The disclosure further provides the film structure and article according to any embodiment herein except that the film structure further comprises an additional layer which comprises one or more polymers selected from the group consisting of polyamide, polyesters, ionomers, cyclic olefin polymers, and EVOH, wherein the additional layer comprises less than or equal to 10 wt % of the film structure.

The disclosure further provides the film structure and article according to any embodiment herein except that the film structure further comprises a second tie layer disposed between the interal layer and the second surface layer.

The disclosure further provides the film structure and article according to any embodiment herein except that the article is selected from the group consisting of thermoformed trays or packages for liquids, particulates and/or solids.

The film thickness will depend on the thermoform depth and could be from 30 μm to 250 μm.

The present invention may be embodied in other forms without departing from the spirit and the essential attributes thereof, and, accordingly, reference should be made to the appended claims, rather than to the foregoing specification, as indicating the scope of the invention.

### EXAMPLES

The following examples illustrate the present invention but are not intended to limit the scope of the invention.

The films were produced using 13 different materials (Table 1). Resins 1, 2 and 7 are LLDPE produced using a metallocene catalyst; resins 3 and 4 are ULLDPE produced using a Ziegler-Natta catalyst; resins 5 and 6 are ethylene propylene copolymers produced using a metallocene catalyst; resin 8 is an LDPE; resins 9 and 10 are ethylene-vinyl acetate copolymers and have 18 and 26.7% by weight of vinyl acetate comonomer content, respectively; resin 11 is a polypropylene homopolymer; and resins 12 and 13 are copolymers of vinylidene chloride and methyl acrylate commonly referred to as PVDC and having a molecular weight from 86000 to 99000 daltons.

TABLE 1

| | Melt Index (190° C. 2.16 kg) | Density |
|---|---|---|
| | (g/10 min) | (g/cm³) |
| Resin 1 | 1.00 | 0.904 |
| Resin 2 | 3.00 | 0.902 |
| Resin 3 | 0.80 | 0.905 |
| Resin 4 | 4.00 | 0.904 |
| Resin 5 | 2.00 | 0.888 |
| Resin 6 | 8.00 | 0.876 |
| Resin 7 | 4.00 | 0.916 |
| Resin 8 | 1.90 | 0.922 |
| Resin 9 | 2.50 | 0.940 |
| Resin 10 | 2.00 | 0.951 |
| Resin 11 | 2.00 | 0.905 |
| Resin 12 | — | 1.700 |
| Resin 13 | — | 1.700 |

The film structures have the structure shown in Table 2 and all film structures have a total thickness of 150 μm. As used in Table 2, the term “Inside Skin Layer” refers to a layer which would be closet to or abutting the contents of a container made from the film and is also referred to herein as the second surface layer. The “Inside Tie Layer,” as used in Table 2, refers to a tie layer disposed between the Inside Skin Layer and the Barrier Layer. As used in connection with Table 2, the term “Barrier Layer” corresponds to the “internal layer” as that term is used herein. The term “Outside Tie Layer” refers to a tie layer disposed between the barrier layer and the Outside Bulk Layer. The outside tie layer is an optional component of the inventive film structure. The “Outside Bulk Layer,” as that term is used in Table 2, refers to an optional layer disposed between the Outside Tie Layer and the Outside Skin Layer. The Outside Skin Layer refers to the film layer that is furthest from the contents of a container made from the film and is also referred to the first surface layer herein.

TABLE 2

| | Inventive | Inventive | Inventive | Comparative |
|---|---|---|---|---|
| | Example 1 | Example 2 | Example 3 | Example |
| Extrusion process | Blown | Cast | Cast | Cast |
| Inside Skin Layer | 25% by volume | 38% by volume | 38% by volume | 26% by volume |
| | Resin 1 (80%) + | Resin 2 (80%) + | Resin 4 (100%) | Resin 2 (80%) + |
| | Resin 8 (20%) | Resin 8 (20%) | | Resin 8 (20%) |
| Inside Tie Layer | 8% by volume | 8% by volume | 8% by volume | 8% by volume |
| | Resin 9 (100%) | Resin 10 (100%) | Resin 10 (100%) | Resin 10 (100%) |
| Barrier Layer | 8% by volume | 8% by volume | 8% by volume | 8% by volume |
| | Resin 12 (100%) | Resin 13 (100%) | Resin 13 (100%) | Resin 13 (100%) |
| Outside Tie Layer | 8% by volume | 8% by volume | 8% by volume | 8% by volume |
| | Resin 9 (100%) | Resin 10 (100%) | Resin 10 (100%) | Resin 10 (100%) |
| Outiside Bulk Layer | 26% by volume | — | — | — |
| | Resin 3 (80%) + | | | |
| | Resin 8 (20%) | | | |
| Outside Skin Layer | 25% by volume | 38% by volume | 38% by volume | 50% by volume |
| | Resin 5 (100%) | Resin 6 (100%) | Resin 7 (100%) | Resin 11 (70%) + |
| | | | | Resin 6 (30%) |

### Film Properties

Inventive Film Structures 1-3 and Comparative Film Structure 1 were submitted to a thermoforming test in order to analyze the performance of the films. The test was conducted in a MULTIVAC R145 and the thermoformed package size was 115 mm by 150 mm. All the samples were thermoformed using different depths: 1 cm; 1.5 cm; 4 cm; 6 cm. As the deep increases, the film thickness is reduced, and the critical point is in the thermoforming corners. The thermoforming parameters that have direct influence on the final properties of the package are the vacuum time and heat temperature. For all the samples that were analyzed, the parameters were the following: vacuum time=1.5 s and heat temperature=95° C. The corners of the thermoformed trays from Inventive Examples 1-3 showed comparable thickness to those of the tray formed using Comparative Example 1.

Additional film samples having the compositions (in wt %) shown in Table 3 were prepared and their gas barrier and physical properties were determined. Tables 3 and 4 provide the oxygen transmission rate (OTR) and water vapor transmission rate (WVTR), respectively, for these samples. As can be seen, the Inventive film shows a lower OTR and WVTR than the Comparative Films of the same overall film thickness.

Resin designated under the tradenames AFFINITY, VERSIFY, ENGAGE, ELITE and ATTANE are commercially available from The Dow Chemical Company. AFFINITY 1881G is a polyolefin plastomer having a density of 0.906 g/cc and an I₂ of 1.0 g/10 min. AFFINITY 1850G is a polyolefin plastomer having a density of 0.902 g/cc and an I₂ of 3.0 g/10 min. ATTANE 4404G is an ultra low density polyethylene having a density of 0.904 g/cc and an I₂ of 4.0 g/10 min. ATTANE 4203 is an ultra low density polyethylene having a density of 0.907 g/cc and an I₂ of 0.8 g/10 min. VERSIFY 3200 is a propylene base plastomer having a density of 0.876 g/cc, measured according to ASTM D-792 and a melt flow rate of 8 g/10 min, measured according to ASTM D -1238 (230° C., 2.16 kg). ELITE 5230G is a polyethylene resin having a density of 0.918 g/cc and an I₂ of 4 g/10 min. LDPE 501 is a high pressure ethylene homopolymer having melt index of about 2 g/10 min. (I₂), density of about 0.922 g/cc, and Tm of about 108° C., which is commercially available from The Dow Chemical Company. ELVAX 3170 is an ethylene vinyl acetate copolymer having a density of 0.94 g/cc and an 12 of 2.5 g/10 min, which is commercially available from E.I. du Pont de Nemours and Company, Inc. ESCORENE 761.36 is an ethylene vinyl acetate copolymer having a density of 0.951 g/cc and a vinyl acetate content of 26.7% which is commercially available from ExxonMobil Chemical Company. SARAN XUS 32727.00 is a PVDC copolymer having a 7.6 methyl acrylate copolymer and a density of 1.7 g/cc and a DSC melting temperature of 151° C.

TABLE 3

| | Inventive Ex. 4 | Inventive Ex. 5 | Inventive Ex. 6 | Inventive Ex. 7 |
|---|---|---|---|---|
| Blown or Cast | Blown | Cast | Cast | Cast |
| Inside Skin Layer | 25% by volume— | 38% by volume— | 50% by volume— | 38% by volume— |
| | AFFINITY 1881G | VERSIFY 3200 | 60% PP H314-02, | ATTANE 4404G |
| | (80%) + LDPE 501 | | 28% VERSIFY | |
| | (20%) | | 3200, 12% | |
| | | | ENGAGE 8200 | |
| Inside Tie Layer | 8% by volume— | 8% by volume— | 8% by volume— | 8% by volume— |
| | EL VAX 3170 | ESCORENE | ESCORENE | ESCORENE |
| | | 761.36 | 761.36 | 761.36 |
| Barrier Layer | 8% by volume— | 8% by volume— | 8% by volume— | 8% by volume— |
| | SARAN XUS | SARAN XUS | SARAN XUS | SARAN XUS |
| | 32019.10L | 32727.00 | 32727.00 | 32727.00 |
| Outside Tie Layer | 8% by volume— | 8% by volume— | 8% by volume— | 8% by volume— |
| | EL VAX 3170 | ESCORENE | ESCORENE | ESCORENE |
| | | 761.36 | 761.36 | 761.36 |
| Outside Bulk Layer | 26% by volume— | N/A | N/A | N/A |
| | ATTANE 4203 | | | |
| | (80%) + LDPE 501 | | | |
| | (20%) | | | |
| Outside Skin Layer | 25% by volume— | 38% by volume— | 26% by volume— | 38% by volume— |
| | VERSIFY 2000 | AFFINITY 1850G | AFFINITY 1850G | ELITE 5230G |
| | | (80%) + LDPE 501 | (80%) + LDPE 501 | |
| PROPERTIES | | (20%) | (20%) | |
| Film Thickness | 6.0 mils | 6.0 mils | 6.0 mils | 6.0 mils |
| OTR (23° C., 50% | 0.10 cc/100 in²- | 0.20 cc/100 in²- | 0.25 cc/100 in²- | 0.22 cc/100 in²- |
| RH) ASTM D3985 | day-atm | day-atm | day-atm | day-atm |
| WVTR (100° F., 100% | 0.06 g/100 in²-day | 0.08 g/100 in²-day | 0.08 g/100 in²-day | 0.08 g/100 in²-day |
| RH) ASTM F1249 | | | | |

TABLE 4

| | Inv. Ex. 4 | Inv. Ex. 5 | Inv. Ex. 6 | Inv. Ex. 7 |
|---|---|---|---|---|
| Modulus (0.5 in/min, 5″ gap, 11.2 lbf | | | | |
| full scale), ASTM D882 | | | | |
| 1% Secant, MD, psi | 39,346 | 26,008 | 37,903 | 23,694 |
| 1% Secant, TD, psi | 39,082 | 26,118 | 34,916 | 23,378 |
| 2% Secant, MD, psi | 29,227 | 21,512 | 27,601 | 20,890 |
| 2% Secant, TD, psi | 28,277 | 21,312 | 27,808 | 21,184 |
| Tensile (20 in/min, 2″ gap,112 lbf full | | | | |
| scale) ASTM D882 | | | | |
| Ultimate Tensile, MD, psi | 2,953 | 3,046 | 3,892 | 2,888 |
| Ultimate Tensile, TD, psi | 2,583 | 2,763 | 3,613 | 2,600 |
| Ultimate Elongation, MD, % | 505 | 526 | 568 | 555 |
| Ultimate Elongation, TD, % | 475 | 580 | 606 | 545 |
| Toughness | | | | |
| Elmendorf Tear, ASTM D1922—MD, g | 850 | 1030 | 973 | 858 |
| Elmendorf Tear, ASTM D1922 —TD, g | 1738 | 1834 | 2618 | 870 |
| Dart Impact—26″ drop, ASTM D1709, g | 229 | 346 | 716 | 329 |
| Adhesion | | | | |
| Heat Seal, ASTM F88, 350° F., 30 psi, | | | | |
| 1 sec | | | | |
| in-to-in, Max. Load, lb/in | 2.3 | 2.9 | 0 | 0 |
| out-to-out, Max. Load, lb/in | 0 | 0.7 | 0.4 | 0 |
| COF, ASTM D1894, 200 g sled, 6″/min, | | | | |
| 2 kgf full scale, MD | | | | |
| Static in-to-in | 0.13 | >1.0 | 0.26 | >1.0 |
| Static out-to-out | 0.60 | >1.0 | 0.30 | >1.0 |

1. A film structure suitable for use in thermoforming applications comprising:
a first surface layer which comprises a polymeric material selected from the group consisting of LLDPE, MDPE, and polypropylene and blends thereof, wherein the polymeric material has a melting point of at least 95° C. and a total crystallinity from 25 to 45%;
a first tie layer comprising at least one component selected from the group consisting of EVA, EEA, EMA, and EBA;
an internal layer which comprises a PVDC copolymer; and
a second surface layer which comprises an LLDPE having a density of from 0.865 to 0.925 g/cm³ and a melt index, I₂, of less than 6.0 g/10 min, and wherein the film structure is characterized by comprising less than or equal to 10% by weight of the film structure of total amount of components selected from the group consisting of polyamides, polyesters, ethylene vinyl acetate, ionomers, polyvinyl chloride, and cyclic olefin polymers, and wherein the internal layer represents from 6 to 25% of a total thickness of the film structure.

2. The film structure according to claim 1, wherein the first surface layer comprises a propylene-based plastomer or elastomer.

3. The film structure according to claim 1, wherein the first surface layer comprises from 50 to 100 wt % linear low density polyethylene, MDPE, propylene-based plastomers, propylene-based elastomers or blends thereof.

4. The film structure according to claim 1, wherein the film structure is a blown film.

5. The film structure according claim 1, wherein the film structure is a cast film.

6. The film structure according to claim 1, wherein the total film structure comprises less than 35 wt % polyethylene having a density of 0.930 g/cm³ or greater, based on the total weight of the film structure.

7. The film structure according to claim 1, wherein the second surface layer is a linear low density polyethylene polymer having a melt index (I₂) from 0.75 to 0.95 g/10 min and a density from 0.91 to 0.93 g/cc.

8. The film structure according to claim 1, wherein the first surface layer is a linear low density polyethylene polymer having a melt index (I₂) from 0.75 to 0.95 g/10 min and a density from 0.91 to 0.93 g/cc.

9. The film structure according to claim 1, wherein one or both of the first and second surface layers further comprises LDPE.

10. The film structure according to claim 1, wherein the film structure has a total thickness from 50 to 300 microns.

11. The film structure according to claim 1, wherein the film exhibits one or both of the following properties: an OTR, measured according to ASTM D3985 at 23° C. and 50% relative humidity, less than or equal to 10 cc/100 in²-day-atm; and a WVTR, measured according to ASTM F1249 at 100 F and 100% relative humidity, less than or equal to 0.2 g/100 in²-day.

12. The film structure according to claim 1, wherein the film exhibits one or both of the following properties: an OTR, measured according to ASTM D3985 at 23° C. and 50% relative humidity, less than or equal to 0.75 cc/100 in²-day-atm; and a WVTR, measured according to ASTM F1249 at 100° F. (37.8° C.) and 100% relative humidity, less than or equal to 0.1 g/100 in²-day.

13. The film structure according to claim 1, wherein the film structure contains from 4 to 14 distinct layers.

14. The film structure according to claim 1, wherein the film structure contains from 5 to 9 distinct layers.

15. The film structure according to claim 1, further comprising a second tie layer disposed between the internal layer and the second surface layer.

16. An article to hold liquids, particulates or solids comprising the film structure according to claim 1.

17. The article according to claim 16 selected from the group consisting of thermoformed trays or packages for liquids, particulates and/or solids.
